(19) United States
(12) Patent Application Publication
(10) Pub. No.: US 2008/0189406 A1
(43) Pub. Date: Aug. 7, 2008

(54) System and method of a peer-to-peer web service monitoring network

(76) Inventor: Jian Shen, Fremont, CA (US)

Correspondence Address: Raj Abhyanker, LLP;c/o Intellevate,, P.O.Box 52050, Minneapolis,, MN, 55402, US

(21) Appl. No.: 11/702,805

(22) Filed: Feb. 5, 2007

(51) Int. Cl. G06F 15/16

(52) U.S. Cl. 709/224

(57) ABSTRACT

A system and method of a peer-to-peer web service monitoring network is disclosed. In one embodiment, a method of a central module of a peer-to-peer monitor networking includes embedding any number of monitoring agents of the peer-to-peer monitor network to any number of websites individually participating in the peer-to-peer monitor network, accessing a target website of the peer-to-peer monitor network through executing a set of command data using the monitoring agents and generating diagnostic data of the target website based on the accessing the target website. In addition, the method may include automatically assigning another monitoring agent of the peer-to-peer monitor network to monitor the target website when any one of the monitoring agents fails to perform the accessing the target website. The method may also include pinging the target website to test an availability of the target website based on the set of command data.

### FIELD OF TECHNOLOGY

This disclosure relates generally to the technical fields of software and/or hardware technology and, in one example embodiment, to system and method of a peer-to-peer web service monitoring network.

### BACKGROUND

Web-sites, web blogs and/or web-based service portals may be an increasingly popular means for businesses and/or individuals to share information, provide services, reach a wide audience and/or advertise products. Since advances in technology have allowed increasingly numerous and complex transactions (e.g., exchange of information, content delivery, etc.), malfunctions, errors, failures and/or suboptimal performance of a website may result in serious negative consequences.

For example, the website (e.g., an entity and/or a provider of the website) may lose business if the website is not available, unreliable, and/or performs poorly (e.g., crashes frequently, responds sluggishly, and/or drops a connection of a user to the website, and/or is not available when many users visit the website at the same time).

Multi-user real-time collaboration service providers may demand higher availability, reliability and/or performance standard due to their higher visibility and/or exposure to critical business processes on a side of the user. Even for personally oriented service providers like IM (internet messenger), blog, and/or SNS (social networking service), consistency and/or optimal performance may be crucial.

An individual and/or an organization running the website and/or server may not have an adequate visibility of site performance fluctuations and/or inefficiencies. There may be a limited range of options for implementing website maintenance and/or monitoring functions, either internally or through third-party providers. For example, web monitoring service providers may charge fees for access to their services, may not support a wide range of client protocols and/or infrastructural architectures, and/or may have limited resources to customize and/or distribute monitoring services according to requirements of the individual and/or the organization.

Furthermore, the web monitoring service providers may provide overly simplified solutions with very limited global coverage and/or analytic functionalities. A few high-end internet web monitoring service providers (e.g. Mercury Interactive®, Keynote®, etc.) may provide complex proprietary solutions with a limited global coverage and/or high price tags. However, the few high-end internet web monitoring service providers may focus on serving larger web-based businesses as their services may not be economical for a majority of clients (e.g., smaller web-based businesses and/or the personally oriented service providers).

### SUMMARY OF THE DISCLOSURE

A system and method of a peer-to-peer web service monitoring network is disclosed. In one aspect, a method of a central module of a peer-to-peer monitor network includes embedding any number of monitoring agents (e.g., the monitoring agent may be a thin open source code with less than 100 kilo-bytes in size) of the peer-to-peer monitor network to any number of websites individually participating in the peer-to-peer monitor network, accessing a target website (e.g., the accessing the target website may be performed to gauge a performance and/or a reliability of the target website based on the set of command data) of the peer-to-peer monitor network through executing a set of command data using the monitoring agents and generating diagnostic data of the target website based on the accessing the target website.

The monitoring agents may be selected using an algorithm which considers a capability of an internet service provider (ISP) of each of the websites, a capability of each web server hosting the each of websites, and/or a capability of each target web server hosting the target website. In addition, the method may include automatically assigning another monitoring agent of the peer-to-peer monitor network to monitor the target website when any one of the monitoring agents fails to perform the accessing the target website. The method may further include pinging the target website to test an availability of the target website based on the set of command data.

Also, the method may include rendering a customized analysis of the target website based on parameter data (e.g., the parameter data may include a frequency of the generating the diagnostic data and/or a geographical coverage (e.g., the geographical coverage may include a local, regional, nationwide, continental and/or global coverage of the target website based on the parameter data of the target website) of the accessing the target website) of the target website. Furthermore, the method may include communicating the diagnostic data to the target website and/or to mobile device associated with the target website. Moreover, the method may include generating an alert signal to deliver to the mobile device associated with the target website using an email, a text message, and/or an audible alarm when the diagnostic data exceeds a threshold value.

The method may also include periodically publishing rankings of a pre-selected set of major websites to a graphical user interface (GUI) of the central module based on a combination of an availability, the performance, and the reliability of the pre-selected set of the major websites (e.g., the pre-selected set of the major websites are determined based on a number of factors including at least a popularity of the major websites). In addition, the method may also include enabling the monitoring websites to render a valued added service to clients of the monitoring websites through modifying the thin open source code to customize functions performed by the plurality of monitoring websites.

In another aspect, a method of a monitoring agent of a peer-to-peer monitor network includes parsing a set of command data (e.g., the set of command data may include a web address of the target website) having a list of time-stamped tasks associated with a target website of the peer-to-peer monitor network, executing the set of command data to collect diagnostic data of the target website, and temporarily allocating the diagnostic data to a memory space of a web server hosting the monitoring agent.

Furthermore, the method may include communicating the web address of the web server hosting the monitoring agent to a central module of the peer-to-peer monitor network when the monitoring agent is embedded to the web server. Additionally, the method may include communicating the diagnostic data to the central module during the executing the set of command data based on the list of time-stamped tasks.

In yet another aspect, a system includes a central module to render an analysis of a target website through applying diagnostic data assessing the target website, and any number of monitoring agents embedded to web servers hosting the monitoring agents to execute a set of command of the central module to collect the diagnostic data. The system may include a processor module of the central module to configure the set of command data based on parameter data of the target website and/or a capability of each of the monitoring agents.

Moreover, the system may include a master database of the central module to optimally assign the monitoring agents to the target website based on the parameter data (e.g., the parameter data may include geographic locations of the each of the monitoring agent module and/or a degree of coverage requested by the target website) and/or the capability of the each of the monitoring agents.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a central module communicating with a website and a target website through a network, according to one embodiment.

FIG. 2 is an exploded view of the central module of FIG. 1, according to one embodiment.

FIG. 3 is a table view showing details of the monitoring agent of FIG. 1, according to one embodiment.

FIG. 4 is a user interface view of the GUI of FIG. 2, according to one embodiment.

FIG. 5 is a detailed view of the warning info of FIG. 4, according to one embodiment.

FIG. 6 is a schematic view showing a global distribution of the peer-to-peer monitor network, according to one embodiment.

FIG. 7 is a detailed view of global distribution of a peer-to-peer monitor network in North America of FIG. 6, according to one embodiment.

FIG. 8 is a diagrammatic system view of a data processing system in which any of the embodiments disclosed herein may be performed, according to one embodiment.

FIG. 9 is a process flow of the central module of the peer-to-peer monitor network, according to one embodiment.

FIG. 10 is a process flow of monitoring the target website of the peer-to-peer monitor network, according to one embodiment.

FIG. 11 is a process flow of the monitoring agent in the peer-to-peer monitored network, according to one embodiment.

Other features of the present embodiments will be apparent from the accompanying drawings and from the detailed description that follows.

### DETAILED DESCRIPTION

A system and method of a peer-to-peer web service monitoring network is disclosed. In the following description, for the purposes of explanation, numerous specific details are set forth in order to provide a thorough understanding of the various embodiments. It will be evident, however to one skilled in the art that the various embodiments may be practiced without these specific details.

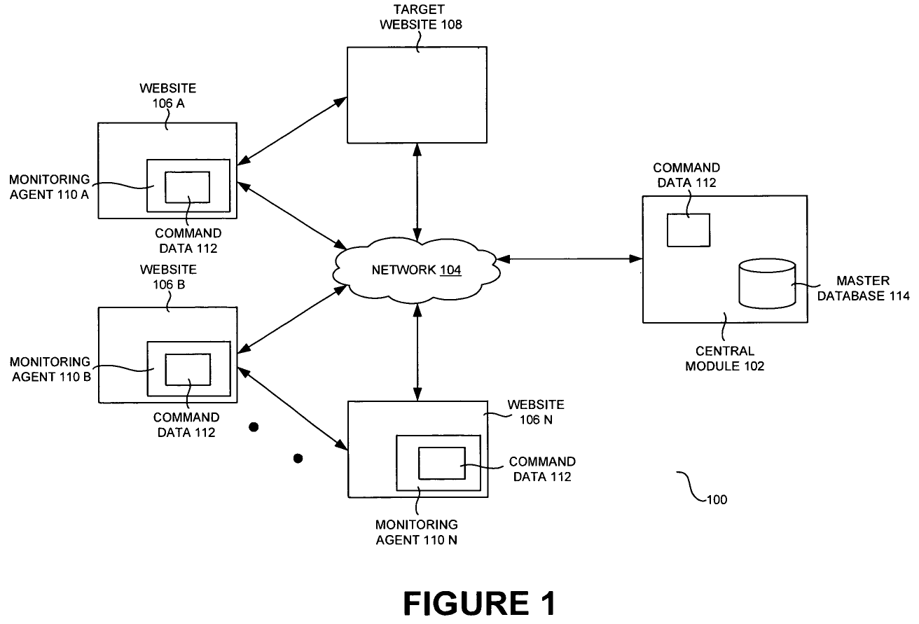

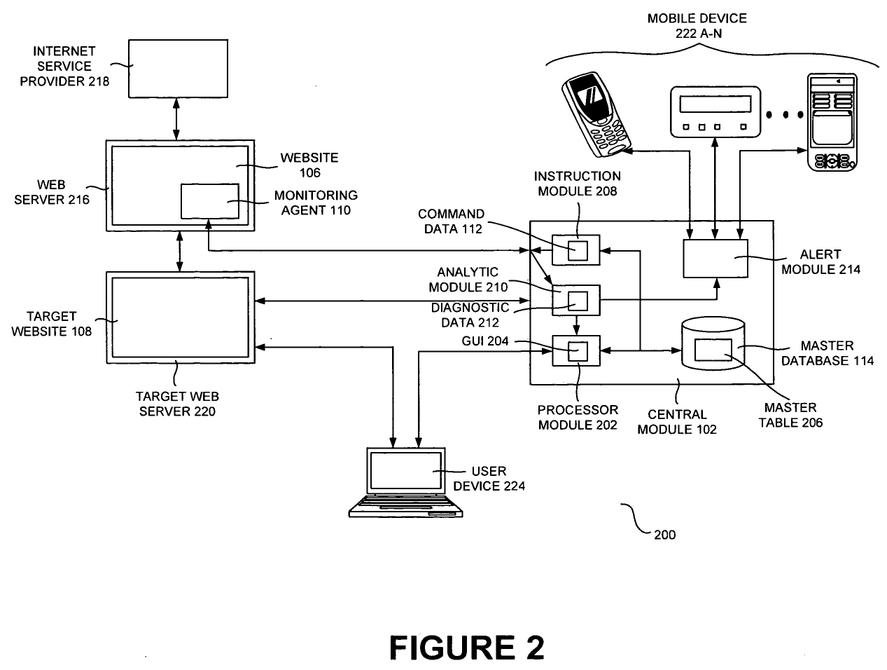

In one embodiment, a method of a central module (e.g., a central module 102 of FIG. 1-2) of a peer-to-peer monitor network includes embedding any number of monitoring agents (e.g., a monitoring agent 110A-N of FIG. 1) of the peer-to-peer monitor network to any number of websites (e.g., a website 106A-N of FIG. 1) individually participating in the peer-to-peer monitor network, accessing a target website (e.g., a target website 108 of FIG. 1) of the peer-to-peer monitor network through executing a set of command data (e.g., command data 112 of FIG. 1-2) using the monitoring agents and generating diagnostic data (e.g., diagnostic data 212 of FIG. 2) of the target website based on the accessing the target website.

In another embodiment, a method of a monitoring agent (e.g., the monitoring agent 110A-N of FIG. 1) of a peer-to-peer monitor network includes parsing a set of command data (e.g., the set of command data may include a web address of the target website) having a list of time-stamped tasks associated with a target website (e.g., the target website 108 of FIG. 1) of the peer-to-peer monitor network, executing the set of command data to collect diagnostic data of the target website, and temporarily allocating the diagnostic data to a memory space of a web server (e.g., a web server 216 of FIG. 2) hosting the monitoring agent.

In yet another embodiment, a system includes a central module (e.g., the central module 102 of FIG. 1-2) to render an analysis of a target website through applying diagnostic data assessing the target website, and any number of monitoring agents embedded to web servers hosting the monitoring agents to execute a set of command of the central module to collect the diagnostic data (e.g., the diagnostic data 212 of FIG. 2).

FIG. 1 is a system view of a central module 102 communicating with a website 106A-N and a target website 108 through a network 104, according to one embodiment. Particularly, FIG. 1 illustrates the central module 102, the network 104, the website 106A-N, the target website 108, a monitoring agent 110A-N, a command data 112, and a master database 114, according to one embodiment.

The central module 102 may perform analysis of the target website 108 through applying a diagnostic data (e.g., the diagnostic data 212 of FIG. 2) accessing the target website 108. The network 104 may enable the central module 102 to interact with the website 106A-N and/or the target website 108. The website 106A-N may be a collection of web pages, typically common to a particular domain name or sub domain on World Wide Web on internet which may individually participate in the peer-to-peer monitor network.

The target website 108 may be the collection of the web pages, typically common to the particular domain name or sub domain on the World Wide Web on the internet that may be accessed through the monitoring agent 110A-N of the website 106A-N to gauge a performance and/or reliability based on the set of command data 112. The monitoring agent 110A-N may be a thin open source code with less than 100 kilo-bytes in size and may be embedded in the web servers (e.g., the web server 216 of FIG. 2) to execute a set of the command data (e.g., the command data 112 of FIG. 1-2).

The monitoring agent 110A-N may execute the set of command data of the central module 102 to generate the diagnostic data (e.g., the diagnostic data 212 of FIG. 2) of the target website 108 of the peer-to-peer monitor network. The command data 112 may be web addresses of the target website 108 which may be executed to access the target website 108 in the peer-to-peer monitor network. The master database 114 of the central module 102 may be computer program that may assign the monitoring agent 110A-N of the website 106A-N to the target website 108 based on a parameter data (e.g., the parameter data may include geographic locations of each of the monitoring agent 110A-N and/or degree of coverage requested by the target website 108) and/or the capability of the monitoring agent 110A-N.

In the example embodiment illustrated in FIG. 1, the central module 102 may include the command data 112 and the master database 114 and may communicate with website 106A-N and/or the target website 108 through the network 104. The website 106A-N may include monitoring agent 110A-N and may communicate directly with the target website 108 as illustrated in example embodiment of FIG. 1.

For example, a plurality of monitoring agents 110A-N (e.g., the monitoring agent 110A-N may be a thin open source code with less than 100 kilo-bytes in size) of the peer-to-peer monitor network may be embedded to any number of websites 106A-N individually participating in the peer-to-peer monitor network. In addition, the target website 108 of the peer-to-peer monitor network may be accessed (e.g., accessing the target website 108 may be performed to gauge the performance and/or the reliability of the target website 108 based on the set of command data) through executing the set of command data (e.g., command data 112 of FIG. 1) using the monitoring agents 110A-N.

Furthermore, another monitoring agent 110A-N of the peer-to-peer monitor network may be assigned automatically to monitor the target website 108 when any one of the monitoring agents 110A-N fails to perform the accessing the target website 108. Also, the target website 108 may be pinged to test an availability of the target website 108 based on the set of command data. Moreover, the monitoring websites 106A-N may be enabled to render a valued added service to clients of monitoring websites 106A-N through modifying the thin open source code to customize functions performed by the monitoring websites 106A-N.

The system includes the central module 102 to render an analysis of the target website 108 through applying the diagnostic data (e.g., the diagnostic data 212 of FIG. 2) assessing the target website 108. In addition, the system includes the monitoring agents 110A-N embedded to web servers (e.g., the web server 216 of FIG. 2) hosting the monitoring agents 110A-N to execute a set of command of the central module 102 to collect the diagnostic data.

Moreover, the system may include the master database 114 of the central module 102 to optimally assign the monitoring agents 110A-N to the target website 108 based on the parameter data (e.g., the parameter data may include the geographic locations of the each of monitoring agents 110A-N and/or a degree of coverage requested by the target website 108) and/or the capability of the each of the monitoring agents 110A-N.

FIG. 2 is an exploded view of the central module 102 of FIG. 1, according to one embodiment. Particularly, FIG. 2 illustrates the central module 102, the website 106, the target website 108, the monitoring agent 110A-N, the command data 112, the master database 114, a processor module 202, a GUI 204, a master table 206, an instruction module 208, an analytic module 210, a diagnostic data 212, an alert module 214, a web server 216, an internet service provider (ISP) 218, a target web server 220, a mobile device 222A-N, a user device 224, according to one embodiment.

The processor module 202 of the central module 102 may configure the set of command data (e.g., the command data 112 of FIGS. 1-2) based on the parameter data of the target website 108 and/or the capability of each of the monitoring agents 110A-N. The GUI 204 may display particular case of user interface for interacting with the user device 224 that may be capable of representing the diagnostic data (e.g., computer, cellular telephones, television sets etc) which may employ graphical images (e.g., geographical indicator of the monitoring agent 110A-N of FIG. 1) and/or widgets in addition to text to represent information and actions available to clients of the peer to peer monitoring network.

The master table 206 of the master database 114 may contain the parameter data of the target website 108 that may be utilized to assign the monitoring agent 110A-N to the target website 108. The instruction module 208 may enable the monitoring agent 110A-N of the website 106A-N to execute the set of command data of the central module 102 while accessing the target website 108 in the peer-to-peer monitor network.

The analytic module 210 may render the analysis of the target website 108 based on the parameter data of the target website 108. The diagnostic data 212 may be the data (e.g., performance data, reliability data, availability data, etc.) generated on accessing the target website 108 through the monitoring agent 110A-N. The alert module 214 may generate an alert signal to deliver to the mobile device 222A-N (e.g., a cell phone, a pager, a PDA, etc.) associated with the target website 108 when the diagnostic data 212 exceeds a threshold value.

The web server 216 may host the website 106 and may be responsible for accepting requests (e.g., a HTFP) from the clients and/or serving responses to the clients (e.g., the HTTP) along with an optional data content. The Internet service provider (ISP) 218 may be an entity (e.g., a business, an organization, etc.) that may be involved in providing the internet service to the web server 216 associated with the peer-to-peer monitor network. The target web server 220 may be a server that may be accessed by the web server 216 hosting the website 106 individually participated in the peer-to-peer monitor network.

The mobile device 222A-N may be (e.g., the cell phone, the pager, the PDA, etc.) associated with the target website 108 and/or may receive the alert signal(s) (e.g., an email, a text message, an audible alarm, etc.) from the alert module 214 when the diagnostic data 212 may exceed the threshold value. The user device 224 may be a laptop, a desktop, etc. that may display customized analysis associated with the target website 108 and may also enable the client to upload and/or download the data (e.g., the performance data, the reliability data, the availability data, etc.) associated with website.

In the example embodiment illustrated in FIG. 2, the central module 102 may communicate with the target web server 220. The processor module 202 of the central module may communicate with the master database 114, the instruction module 208 and the user device 224. The monitoring agent 110A-N of the web server 216 may communicate with the instruction module 208 and the analytic module 210 according to the example embodiment of FIG. 2. The alert module 214 of the central module 102 as illustrated in example embodiment of FIG. 2, may communicate directly with the mobile devices 222. The web server 216 may interact with the internet service provider 218 and the target web server 220.

For example, the diagnostic data 212 of the target website 108 may be generated based on the accessing the target website 108. The monitoring agents 110A-N (e.g., the monitoring agent 110A-N may be the thin open source code with less than 100 kilo-bytes in size) may be selected using an algorithm which considers a capability of the internet service provider (ISP) 218 of each of the websites 106, a capability of each web server 216 hosting the each of the websites 106, and/or a capability of the target web server 220 hosting the target website 108.

In addition, the customized analysis of the target website 108 may be rendered based on parameter data (e.g., the parameter data may include a frequency of the generating the diagnostic data 212 and/or a geographical coverage (e.g., the geographical coverage may include a local, regional, nationwide, continental and/or global coverage of the target website based on the parameter data of the target website 108) of the accessing the target website 108) of the target website 108. Also, the diagnostic data 212 may be communicated to the target website 108 and to the mobile device 222A-N associated with the target website 108.

Furthermore, the alert signal (e.g., the alert module 214 of FIG. 2) may be generated to deliver to the mobile device 222A-N associated with the target website 108 using an email, an text message, and/or an audible alarm when the diagnostic data 212 exceeds the threshold value. Additionally, rankings of a pre-selected set of major websites may be published periodically to the graphical user interface (GUI) 204 of the central module 102 based on a combination of the availability, the performance, and the reliability of the pre-selected set of the major websites (e.g., the pre-selected set of the major websites may be determined based on a number of factors including at least a popularity of the major websites).

Also, the set of command data (e.g., the set of command data may include the web address of the target website 108) having a list of time-stamped tasks associated with the target website 108 of the peer-to-peer monitor network may be parsed. Additionally, the set of command data (e.g., the command data 112 of FIG. 1-2) may be executed to collect the diagnostic data 212 of the target website 108. Furthermore, the diagnostic data 212 may be allocated to a memory space of the web server 216 hosting the monitoring agent 110A-N.

Moreover, the web address of the web server 216 hosting the monitoring agent 110A-N may be communicated to the central module 102 of the peer-to-peer monitor network when the monitoring agent 110A-N is embedded to the web server 216. In addition, the diagnostic data 212 may be communicated to the central module 102 during the executing the set of command data based on the list of time-stamped tasks.

The system may include the central module 102 to render an analysis of the target website 108 through applying the diagnostic data 212 assessing the target website 108. In addition, the system may include the monitoring agents 110A-N embedded to web servers 216 hosting the monitoring agents 110A-N to execute a set of command of the central module 102 to collect the diagnostic data 212.

The system may further include the processor module 202 of the central module 102 to configure the set of command data based on the parameter data of the target website 108 and/or a capability of monitoring agents 110A-N. Moreover, the system may include the master database 114 of the central module 102 to optimally assign the monitoring agents 110A-N to the target website 108 based on the parameter data (e.g., the parameter data may include the geographic locations of the each of monitoring agent 110A-N and/or a degree of coverage requested by the target website 108) and/or the capability of the each of the monitoring agents 110A-N.

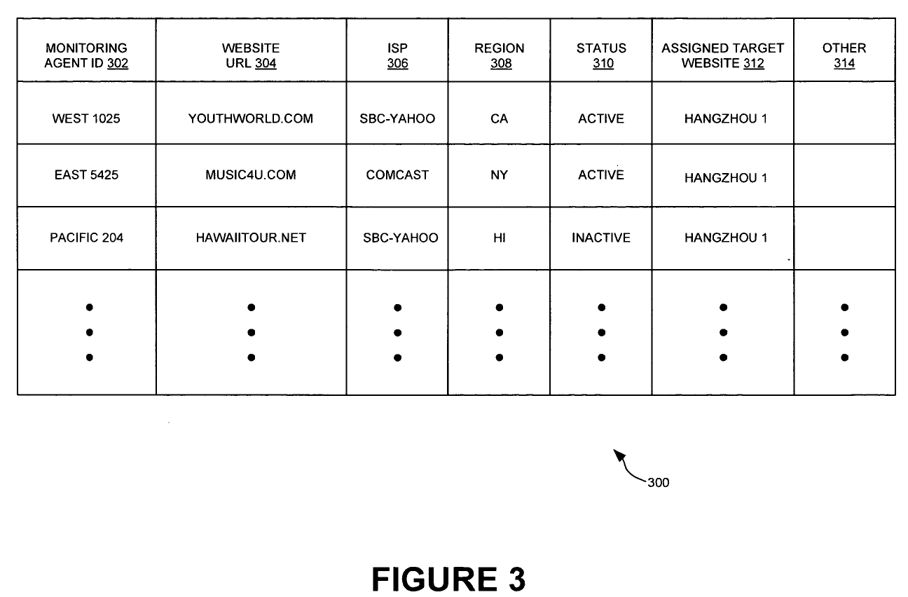

FIG. 3 is a table view 300 showing details of the monitoring agent 110A-N of FIG. 1, according to one embodiment. Particularly, table view 300 of FIG. 3 illustrates a monitoring agent id field 302, a website URL field 304, a ISP field 306, a region field 308, a status field 310, a assigned target website field 312 and others field 314, according to one embodiment.

The monitoring agent id field 302 may display an id assigned by the central module 102 of FIG. 1 to the website 106A-N. The website URL field 304 may display the information associated with the address of the website 106A-N of FIG. 1 to which the monitoring agent id is assigned. The ISP field 306 may display the name of the internet service provider associated with the website 106A-N. The region field 308 may display information associated with the geographic location of the monitoring agent 110A-N.

The status field 310 may display the information associated with the status of the monitoring agent 110A-N accessing the assigned target website (e.g., the target website 108 of FIG. 1). The assigned target website field 312 may display the target website assigned to the any one of the monitoring agents. The others field 314 may display other information (e.g., feed back rating, parameter data, etc.) associated with the monitoring agent in the peer-to-peer monitor network.

In example embodiment illustrated in FIG. 3, the monitoring agent id field 302 displays “west 1025” in the first row, “east 5425” in the second row, and “pacific 204” in the third row of the monitoring agent id field 302 column. The website URL field 304 displays “youthworld.com” in the first row, “music4u.com” in the second row, and “hawaiitour.net” in the third row of the website URL field 304 column.

The ISP field 306 displays “SBC-Yahoo” in the first row, “Comcast” in the second row, and “SBC-Yahoo” in the third row of the ISP field 306 column of the table view 300 of FIG. 3. The region field 308 displays “CA” in the first row, “NY” in the second row, and “HI” in the third row of the region field 308 column.

The status field 3 1 0 displays “active” in the first row, “active” in the second row, and “inactive” in the third row of the status field 310 column as illustrated in example embodiment of FIG. 3. The assigned target website field 312 displays “Hangzhou 1” in the first row, “Hangzhou 1” in the second row, and “Hangzhou 1” in the third row of the assigned target website field 312 column of FIG. 3.

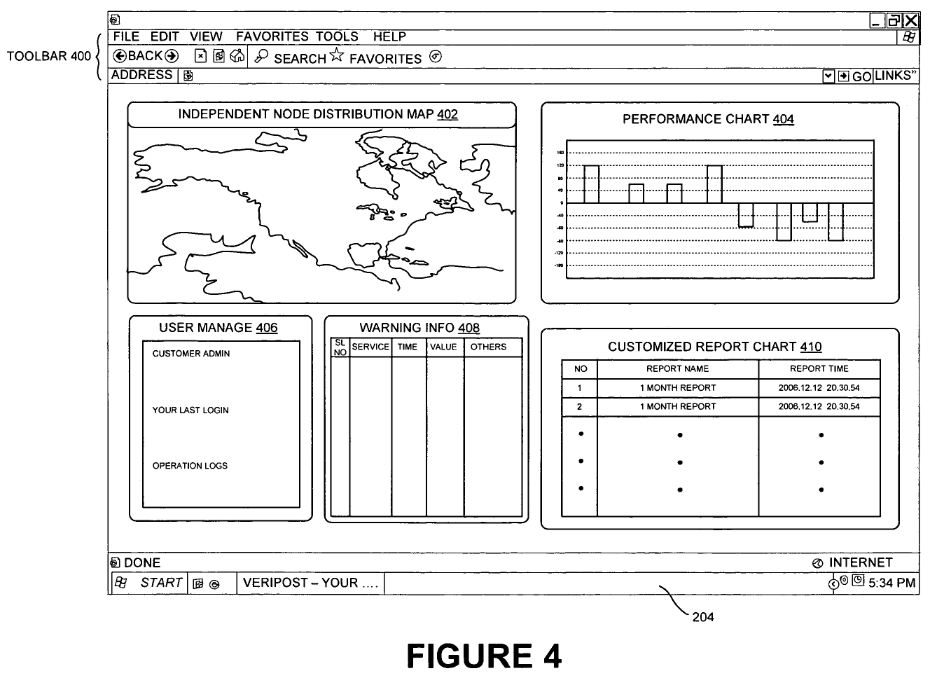

FIG. 4 is a user interface view of the GUI 204 of FIG. 2, according to one embodiment. Particularly, FIG. 4 illustrates a tool bar 400, a independent node distribution map 402, a performance chart 404, a user manage 406, a warning info 408, and a customized report chart 410, according to one embodiment.

The toolbar 400 may enable the user to access the various option through the browser window and may also allow customizing settings of the browser window of the GUI 204. The independent node distribution map 402 may facilitate the client to view the geographical location and distribution of the monitoring agents associated with the target website and other website(s). The performance chart 404 may display the information associated with the performance analysis of the target website.

The user manage 406 may enable the user of the peer-to-peer monitor network to manage (e.g., a view, a record, an update) his/her account details through the GUI 204. The warning info 408 may offer the information associated with the diagnostic data of the target website (e.g., the target website 108 of FIG. 1-2) and/or the alert signal delivered to the respective website when the diagnostic data reaches the threshold value. The customized report chart 410 may facilitate the user to view a monthly report (e.g., a performance report, a reliability report, an availability report, etc.) the associated with the website.

In example embodiment illustrated in FIG. 4, the user interface view of the GUI 204 may enable the user to access the detailed information (e.g., reports, performance analysis, geographical distribution, warning info, etc.) associated with the website (e.g., the target website 108 of FIG. 1) being monitored through peer-to-peer monitor network.

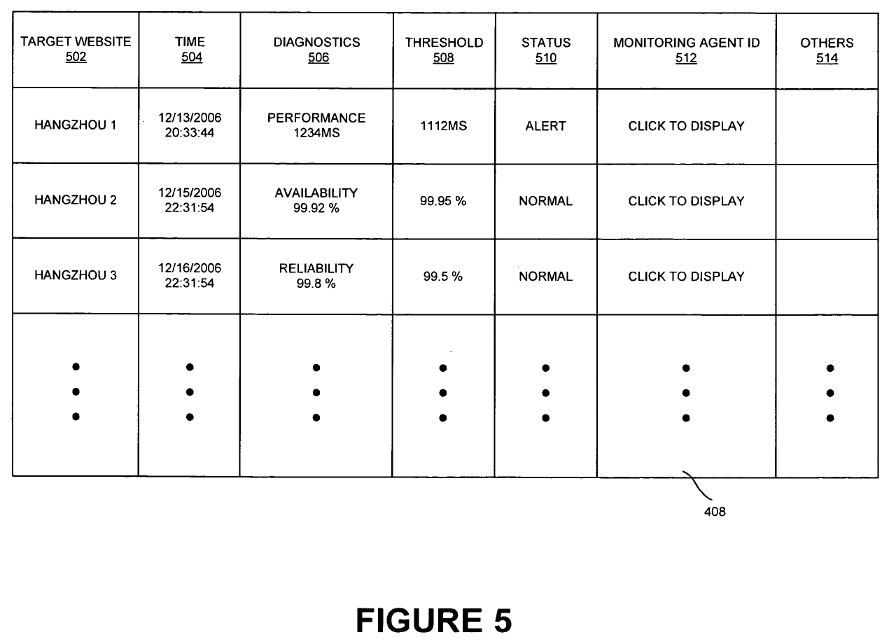

FIG. 5 is a detailed view of the warning info 408 of FIG. 4, according to one embodiment. Particularly, FIG. 5 illustrates a target website field 502, a time field 504, a diagnostic field 506, a threshold field 508, a status field 510, a monitoring agent id field 512, and others field 514, according to one embodiment.

The target website field 502 may display website being monitored through any number of monitoring agents (e.g., the monitoring agent 110A-N of FIG. 1) of the peer-to-peer monitored network. The time field 504 may display the date and/or time of the generation of the diagnostic data associated with the target website (e.g., the target website 108 of FIG. 1). The diagnostics field 506 may display at least one of the performance data, the reliability data, and/or the availability data associated with the particular target website.

The threshold field 508 may display a maximum value below which the website have to perform to obtain best results. The status field 510 may display the information associated with the performance, the reliability, and/or the availability of the specific target website based on the diagnostic data generated on accessing the specific target website. The status field 510 may display information, whether the diagnostic data associated with the specific target website generated is normal or is below the threshold value. The monitoring agent id field 512 may enable the user to view the monitoring agent id assigned by the central module (e.g., the central module 102 of FIG. 1) of the peer-to-peer monitor network through a hyperlink. The others field 514 may display an excess information associated with the specific target website such as degree of coverage, alert details, etc.

In the example embodiment illustrated in FIG. 5, the target website field 502 displays “Hangzhou 1” in the first row, “Hangzhou 2” in the second row and “Hangzhou 3” in the third row of the target website field 502 column of the warning info 408. The time field 504 displays “12/13/2006” in the first row, “12/15/2006” in the second row and “12/16/2006” in the third row of the time field 504 column illustrated in example embodiment of FIG. 5. The diagnostic field 506 displays “performance 1234 ms” in the first row, “availability 99.92%” in the second row and “reliability 99.98%” in the third row of the diagnostic field 506 column.

The threshold field 508 displays “1112 ms” in the first row, “99.95%” in the second row, and “99.5%” in the third row of the threshold field 508 column. The status field 510 displays “alert” in the first row, and “normal” in the second and third row of the status field 510 column of the warning info 408. The monitoring agent id field 512 displays a hyperlink “click to display” in the first, second and third row of the monitoring agent id field 512, according to the example embodiment illustrated in FIG. 5.

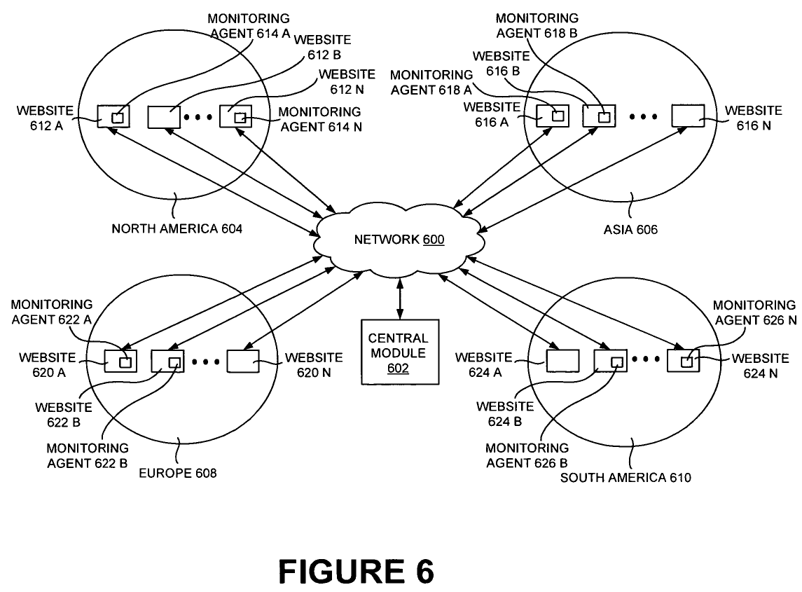

FIG. 6 is a schematic view showing a global distribution of the peer-to-peer monitor network, according to one embodiment. Particularly, FIG. 6 illustrates a network 600, a central module 602, North America 604, Asia 606, Europe 608, South America 610, a website 612A-N, a monitoring agent 614A-N, a website 616A-N, a monitoring agent 618A-B, a website 620A-N, a monitoring agent 622B-N, a website 624A-N, and a monitoring agent 626B-N, according to one embodiment.

The network 600 may enable the central module 602 to communicate the diagnostic data associated to the target website (612A-N, 616A-N, 620A-N, 624A-N) through the plurality of monitoring agent (614A, 614N, 618A, 618B, 622A, 622B, 626B, 626N) located in different geographical regions such as North America 604, Asia 606, Europe 608, South America 610, etc. The central module 602 may communicate with the any number of monitoring agents (614A, 614N, 618A, 618B, 622A, 622B, 626B, 626N) that may be globally distributed in the peer-to-peer monitor network in different geographical regions.

The monitoring agents (614A, 614N, 618A, 618B, 622A, 622B, 626B, 626N) may execute the set of command data to generate the diagnostic data of the target website (e.g., the website 612B, the website 616N, the website 620N, the website 624A, etc.) and may communicate the generated diagnostic data with the central module 602 located at a particular location.

The website (612A-N, 616A-N, 620A-N, 624A-N) may be website located in the any geographical locations and may be monitored through the any number of monitoring agents (614A, 614N, 618A, 618B, 622A, 622B, 626B, 626N) globally distributed in the peer-to-peer monitor network.

In example embodiment illustrated in FIG. 6, the central module 602 may communicate with the plurality of websites (612A-N, 616A-N, 620A-N, 624A-N) located in the different geographical region of North America 604, Asia 606, Europe 608 and South America 610 through the network 600. FIG. 6 illustrates the global distribution of the plurality of monitoring websites (612A-N, 616A-N, 620A-N, 624A-N) in North America 604, Asia 606, Europe 608, South America 610 that may be coordinated through the central module 602 of the peer-to-peer monitor network.

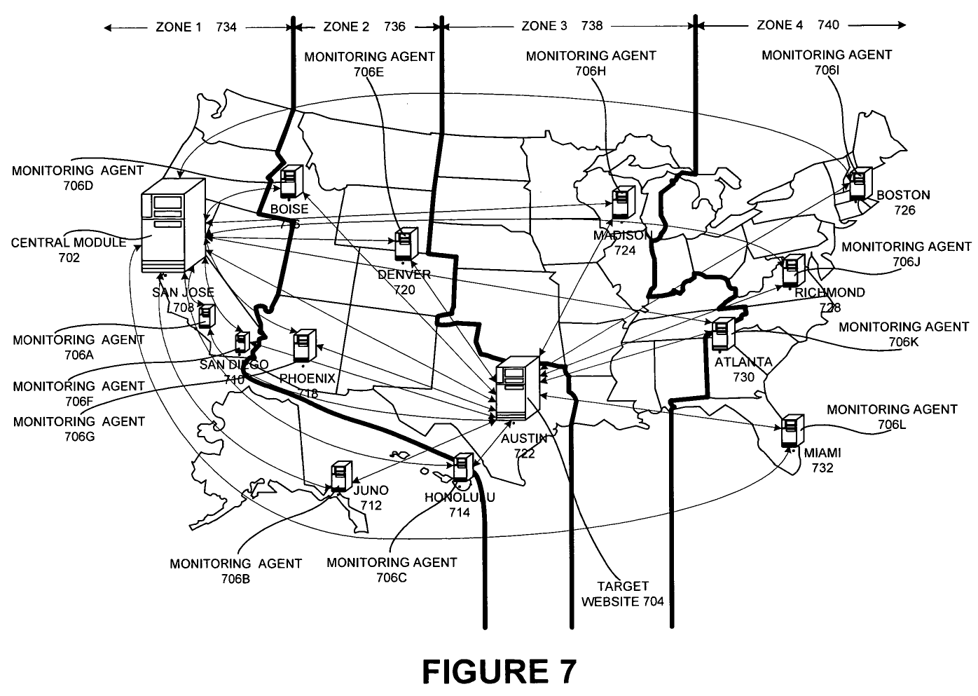

FIG. 7 is a detailed view of global distribution of a peer-to-peer monitor network in North America 604 of FIG. 6, according to one embodiment. Particularly FIG. 7 illustrates a central module 702, a target website 704, a monitoring agent 706A-L, a zone 1 734, a zone 2 736, a zone 3 738 and a zone 4 740, according to one embodiment.

The central module 702 may communicate the diagnostic data of the target website 704 through the any number of monitoring agents 706A-L located in different geographical regions in North America 604. The target website 704 embedded in a target server may be monitored through plurality of the monitoring agents 706A-L distributed in different zones (e.g., the zone 1, the zone 2, the zone 3, and the zone 4) of North America. 604. The monitoring agent 706A-L may access target website 704 to generate diagnostic data which may be the performance data, the availability data and/or the reliability data. The global distribution of a peer-to-peer monitoring network in North America 604 may be divided into different zones (e.g. the zone 1 734, the zone 2 736, the zone 3 738, the zone 4 740 of FIG. 7).

In one example embodiment illustrated in FIG. 7, San Jose 708, Santiago 710, Juno 712 and Honolulu 714 may be covered by the zone 1 734. The zone 2 736 may cover Boise 716, Phoenix 718, Denver 720 and Austin 722. Madison 724 may come under the zone 3 738. The zone 4 740 may cover Boston 726, Richmond 728, Atlanta 730 and Miami 732. In example embodiment illustrated in FIG. 7, the monitoring agents 704A-L distributed in the zone 1 734, the zone 2 736, the zone 3 738, the zone 4 740 of a peer-to-peer monitor network in North America 604 may communicate with the target website 704 located in a specific location (e.g. Austin 722 of the zone 2 736 of FIG. 7).

The central module 702 located in San Jose 708 may communicate with a plurality of monitoring agents 706A-L located in the zone 1 734, the zone 2 736, the zone 3 738, the zone 4 740 of a peer-to-peer monitor network in North America 604. In the example embodiment illustrated in FIG. 7, the target website 704 located in Austin 722 of zone 2 736 may be accessed by any of the monitoring agents 706A-L located in the zone 1 734, the zone 2 736, the zone 3 738, the zone 4 740 of the peer-to-peer monitoring network in North America 604 depending on the degree of coverage preferred by the target website 704.

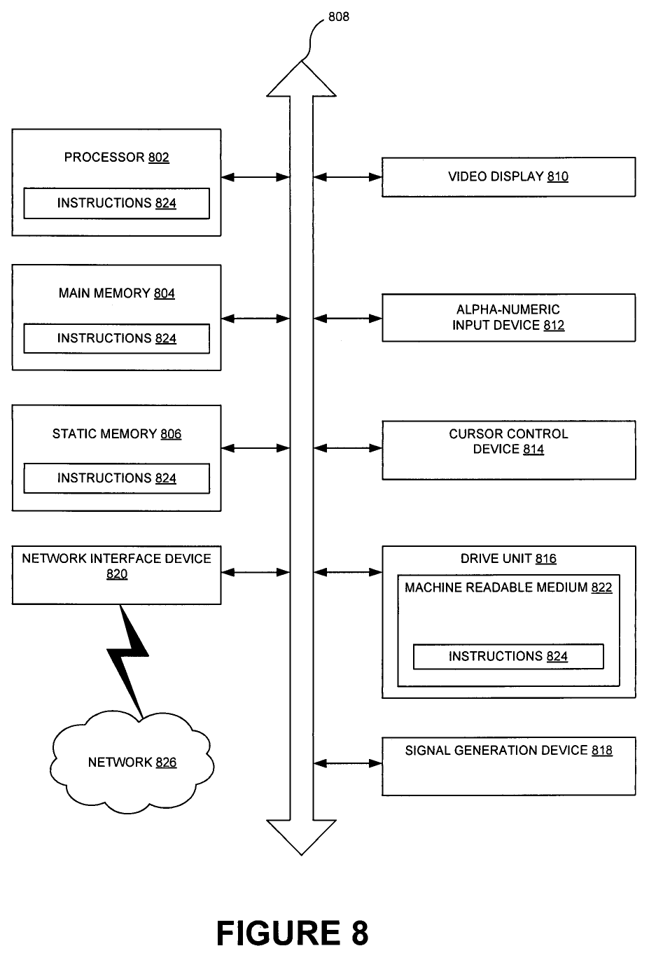

FIG. 8 is a diagrammatic system view 800 of a data processing system in which any of the embodiments disclosed herein may be performed, according to one embodiment. Particularly, the diagrammatic system view 800 of FIG. 8 illustrates a processor 802, a main memory 804, a static memory 806, a bus 808, a video display 810, an alpha-numeric input device 812, a cursor control device 814, a drive unit 118, a signal generation device 818, a network interface device 820, a machine readable medium 822, instructions 824, and a network 826, according to one embodiment.

The diagrammatic system view 800 may indicate a personal computer and/or a data processing system in which one or more operations disclosed herein are performed. The processor 802 may be microprocessor, a state machine, an application specific integrated circuit, a field programmable gate array, etc. (e.g., Intel® Pentium® processor). The main memory 804 may be a dynamic random access memory and/or a primary memory of a computer system.

The static memory 806 may be a hard drive, a flash drive, and/or other memory information associated with the data processing system. The bus 808 may be an interconnection between various circuits and/or structures of the data processing system. The video display 810 may provide graphical representation of information on the data processing system. The alpha-numeric input device 812 may be a keypad, keyboard and/or any other input device of text (e.g., a special device to aid the physically handicapped). The cursor control device 814 may be a pointing device such as a mouse.

The drive unit 816 may be a hard drive, a storage system, and/or other longer term storage subsystem. The signal generation device 818 may be a bios and/or a functional operating system of the data processing system. The network interface device 820 may be a device that may perform interface functions such as code conversion, protocol conversion and/or buffering required for communication to and from the network 826. The machine readable medium 822 may provide instructions on which any of the methods disclosed herein may be performed. The instructions 824 may provide source code and/or data code to the processor 802 to enable any one/or more operations disclosed herein.

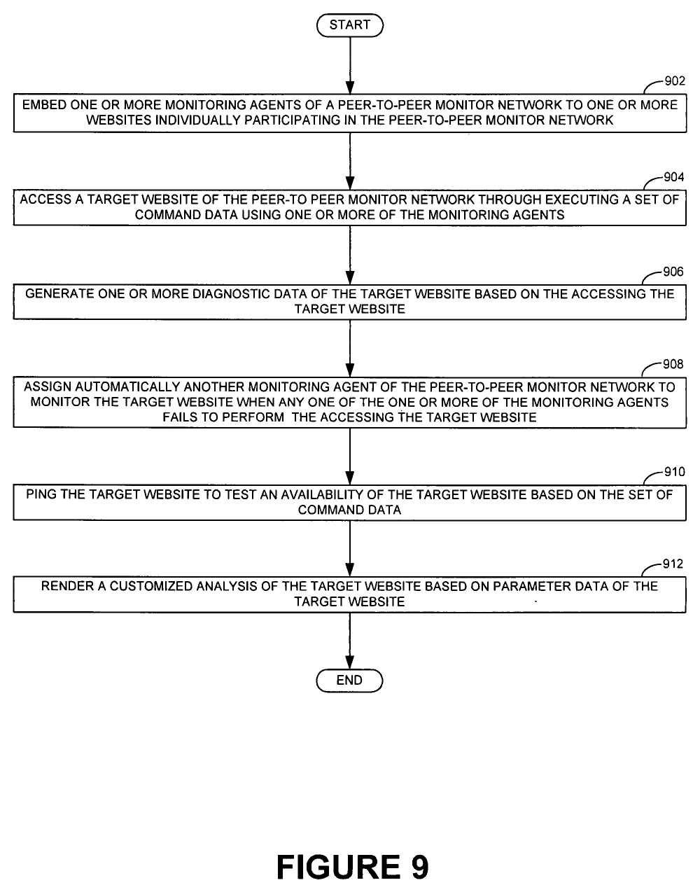

FIG. 9 is a process flow of the central module 102 of a peer-to-peer monitor network, according to one embodiment. In operation 902, one or more monitoring agents (e.g., the monitoring agent 110A-N of FIG. 1-2) of the peer-to-peer monitor network may be embedded to one or more websites individually participating in the peer-to-peer monitor network. In operation 904, a target website (e.g., the target website 108 of FIG. 1-2) of the peer-to-peer monitor network may be accessed through executing a set of command data (e.g., the command data 112 of FIG. 1-2) using one or more of the monitoring agents. In operation 906, one or more diagnostic data (e.g., the diagnostic data 212 of FIG. 2) of the target website may be generated based on the accessing the target website.

In operation 908, another monitoring agent of the peer-to-peer monitor network may be assigned automatically to monitor the target website when any one of the one or more of the monitoring agents fails to perform the accessing the target website. In operation 910, the target website may be pinged to test an availability of the target website based on the set of command data. In operation 912, a customized analysis of the target website may be rendered based on parameter data of the target website (e.g., the target website 108 of FIG. 1-2).

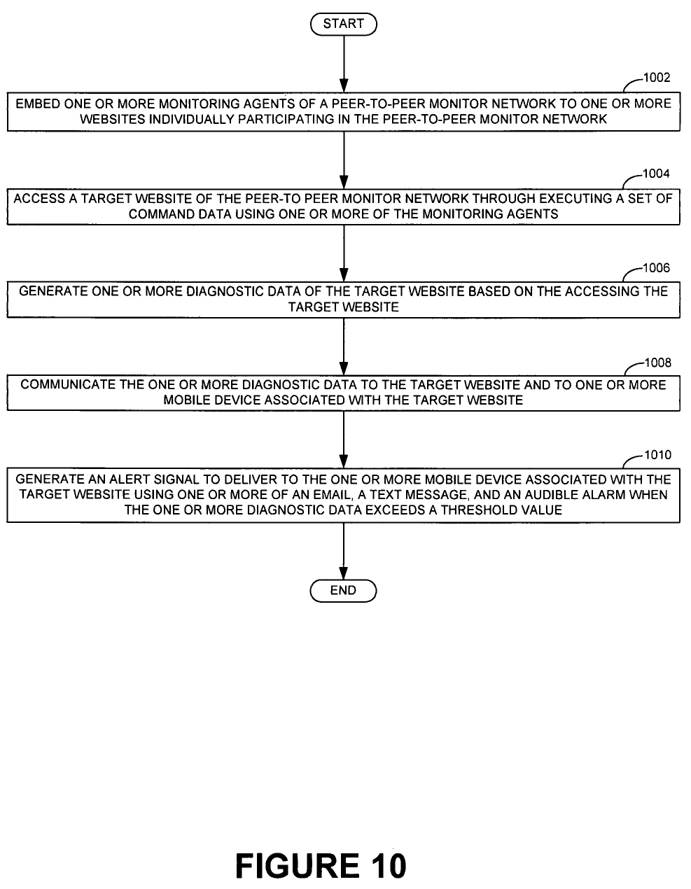

FIG. 10 is a process flow of monitoring the target website 108 of the peer-to-peer monitor network, according to one embodiment. In operation 1002, one or more monitoring agents (e.g., the monitoring agent 110A-N of FIG. 1) of a peer-to-peer monitor network may be embedded to one or more websites individually participating in the peer-to-peer monitor network. In operation 1004, a target website (e.g., the target website 108 of FIG. 1-2) of the peer-to-peer monitor network may be accessed through executing a set of command data (e.g., the command data 112 of FIG. 1-2) using one or more of the monitoring agents.

In operation 1006, one or more diagnostic data (e.g., the diagnostic data 212 of FIG. 2) of the target website may be generated based on the accessing the target website. In operation 1008, one or more diagnostic data may be communicated to the target website and/or to one or more mobile device (e.g., the mobile device 222A-N of FIG. 2) associated with the target website. In operation 1010, an alert signal (e.g., using the alert module 214 of FIG. 2) may be generated to deliver to the one or more mobile device associated with the target website using one or more of an email, a text message and/or an audible alarm when the one or more diagnostic data exceeds a threshold value.

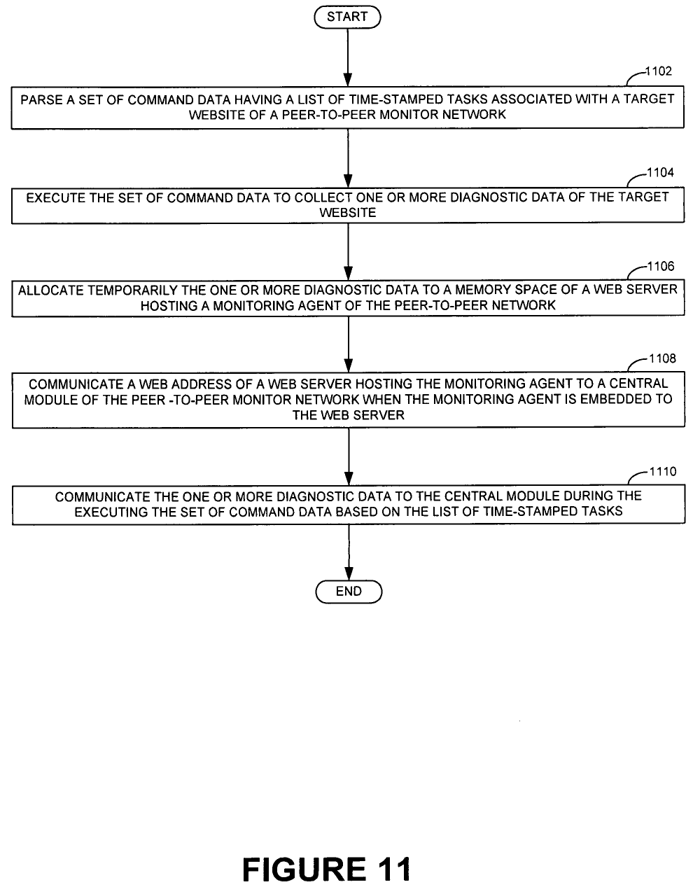

FIG. 11 is a process flow of the monitoring agent 110A-N in the peer-to-peer monitored network, according to one embodiment. In operation 1102, a set of command data (e.g., the command data 112 of FIG. 1) having a list of time-stamped tasks associated with a target website (e.g., the target website 108 of FIG. 1-2) of a peer-to-peer monitor network may be parsed. In operation 1104, the set of command data may be executed to collect one or more diagnostic data (e.g., the diagnostic data 212 of FIG. 2) of the target website. In operation 1106, one or more diagnostic data may be allocated temporarily to a memory space of a web server (e.g., the web server 216 of FIG. 2) hosting a monitoring agent of the peer-to-peer network.

In operation 1108, a web address of a web server hosting a monitoring agent may be communicated to a central module (e.g., the central module 102 of FIG. 1) of a peer-to-peer monitor network when the monitoring agent is embedded to the web server. In operation 1110, one or more diagnostic data may be communicated to the central module during the executing the set of command data based on a list of time-stamped task.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

For example the central module 102, the processor module 202, the instruction module 208, the analytic module 210, the alert module 214 and other modules of FIGS. 1-11 may be embodied through a central circuit, a processor circuit, an instruction circuit, an analytic circuit, an alert circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a central module of a peer-to-peer monitor network, comprising:
embedding a plurality of monitoring agents of the peer-to-peer monitor network to a plurality of websites individually participating in the peer-to-peer monitor network;
accessing a target website of the peer-to-peer monitor network through executing a set of command data using at least one of the plurality of monitoring agents; and
generating at least one diagnostic data of the target website based on the accessing the target website.

2. The method of claim 1, wherein the at least one of the plurality of monitoring agents is selected using an algorithm which considers at least a capability of an internet service provider (ISP) of each of the plurality of websites, a capability of each web server hosting the each of the plurality of websites, and a capability of a web server hosting the target website.

3. The method of claim 2, further comprising automatically assigning another monitoring agent of the peer-to-peer monitor network to monitor the target website when any one of the at least one of the plurality of monitoring agents fails to perform the accessing the target website.

4. The method of claim 3, further comprising pinging the target website to test an availability of the target website based on the set of command data.

5. The method of claim 1, wherein the accessing the target website is performed to gauge at least one of a performance and a reliability of the target website based on the set of command data.

6. The method of claim 4 further comprising rendering a customized analysis of the target website based on parameter data of the target website, wherein the parameter data to include a frequency of the generating the at least one diagnostic data and a geographical coverage of the accessing the target website.

7. The method of claim 6, wherein the geographical coverage to include at least one of a local, regional, nationwide, continental and global coverage of the target website based on the parameter data of the target website.

8. The method of claim 7, further comprising communicating the at least one diagnostic data to the target website and to at least one mobile device associated with the target website.

9. The method of claim 8, further comprising generating an alert signal to deliver to the at least one mobile device associated with the target website using at least one of an email, a text message, and an audible alarm when the at least one diagnostic data exceeds a threshold value.

10. The method of claim 9, further comprising periodically publishing rankings of a pre-selected set of major websites to a graphical user interface (GUI) of the central module based on a combination of an availability, a performance, and a reliability of the pre-selected set of the major websites, wherein the pre-selected set of the major websites are determined based on a number of factors including at least a popularity of the major websites.

11. The method of claim 1, wherein the monitoring agent is a thin open source code with less than 100 kilo-bytes in size.

12. The method of claim 11, further comprising enabling the plurality of monitoring websites to render a valued added service to clients of the plurality of monitoring websites through modifying the thin open source code to customize functions performed by the plurality of monitoring websites.

13. The method of claim 1 in a form of a machine-readable medium embodying a set of instructions that, when executed by a machine, causes the machine to perform the method of claim 1.

14. A method of a monitoring agent of a peer-to-peer monitor network, comprising:
parsing a set of command data having a list of time-stamped tasks associated with a target website of the peer-to-peer monitor network;
executing the set of command data to collect at least one diagnostic data of the target website; and
temporarily allocating the at least one diagnostic data to a memory space of a web server hosting the monitoring agent.

15. The method of claim 14, further comprising communicating a web address of the web server hosting the monitoring agent to a central module of the peer-to-peer monitor network when the monitoring agent is embedded to the web server.

16. The method of claim 15, further comprising communicating the at least one diagnostic data to the central module during the executing the set of command data based on the list of time-stamped tasks.

17. The method of claim 16, wherein the set of command data to include a web address of the target website.

18. A system, comprising:
a central module to render an analysis of a target website through applying at least one diagnostic data assessing the target website; and
a plurality of monitoring agents embedded to web servers hosting the plurality of monitoring agents to execute a set of command data of the central module to collect the at least one diagnostic data.

19. The system of claim 18, further comprising a processor module of the central module to configure the set of command data based on parameter data of the target website and a capability of each of the at least one of the plurality of monitoring agents.

20. The system of claim 19, further comprising a master database of the central module to optimally assign at least one of the plurality of monitoring agents to the target website based on the parameter data and the capability of the each of the at least one of the plurality of monitoring agents, wherein the parameter data to include at least geographic locations of the each of the at least one of the plurality of monitoring agents and a degree of coverage requested by the target website.
